(19) United States
(12) Patent Application Publication
(10) Pub. No.: US 2017/0372641 A1
(43) Pub. Date: Dec. 28, 2017

(54) Repositionable blueprint decals

(71) Applicant: Casey Ann Trudeau, Carmel, CA (US)

(72) Inventor: Casey Ann Trudeau, Carmel, CA (US)

(21) Appl. No.: 15/731,502

(22) Filed: Jun. 20, 2017

Related U.S. Application Data
(60) Provisional application No. 62/493,089, filed on Jun. 22, 2016.

(51) Int. Cl. G09B 29/00

(52) U.S. Cl. CPC G09B 29/001

(57) ABSTRACT

Decals are repositionable, adhering pieces representing a plurality of furniture, fixtures, finishes, construction elements and architectural details for the use in Architectural, Interior, Landscape and/or Engineering Planning and Design. The Hand Drawn and/or Computer Drafted Graphics are Industry Standard and/or Custom Shapes represented as Individual or Grouped designs, specific to an Architectural, Engineering or Metric Scale. Printed on a Master Sheet and Die Cut Shapes result in individual, pliant pieces that peel away from the Master Sheet for application to the End User's Documents or Material, for Design Layout, Notation, Product Purchase Tracking and/or Diagramming Furniture and/or Fixture Installations. Printed in Monotone or Full Color, the durable yet disposable Decals utilize uncoated or coated, clear or opaque, repositionable adhesive paper and/or clear repositionable polypropylene.

Repositionable Blueprint Decals relate generally to the field of residential and commercial design; specifically, standard and/or custom, to scale, printed pieces for the purpose of conceptual or revised plan layouts with the benefit of adhering with repositionable flexibility. Decals improve on furniture/fixture design kits and drafting aids that traditionally offer either hard plastic tracing templates (i.e. “Template Designs, #TD714, or American Standard, #9383-A., Copyright 1970”), or card stock kits lacking adherence (i.e. “Maggi Cobb, Copyright 1958 for Décor Kits, Inc.”), or if adherent they lack repositionability. (Note: The examples provided relate to their Utility function and the differences between them and Repositionable Blueprint Decals.) Repositionable Adhering Paper or Polypropylene is currently manufactured and the Decals will utilize such material without making claim to inventing the repositionable paper or polypropylene. Pliant Decals merge outdated templates/kits with modern repositionable paper and/or polypropylene creating a product to accommodate repetitive design changes without ill effect to the end user's applied-upon material. A coated or uncoated surface, the Decals are a durable yet disposable, adhering, pliable, “sticker” to be used on paper, plastic, metal or glass. Printed and Die Cut, the individual Decals peel from a Master Sheet and represent a standard scale, standard or custom impressions of furniture and/or fixtures, presented as line drawings or full color artwork for Architectural, Interior and Landscape Design.

Repositionable Blueprint Decals are intended to work in tandem with Digital design and printing as the use of paper/printed plans and presentations are an on-going industry standard. Typically, drawings and plans are created with Computer Aided Drafting programs, executed by a professional Architect, Engineer, Designer or Draftsman. The Decals will enhance time and cost efficiency for the end user as the finished product does not require a digital platform or professional knowledge. The Decals can lend immediate visual conclusions to printed plans or presentation boards when computer access is not present, and without permanent altercation to printed plans or other material, and being a pliable adhering product, the Decals can be affixed and roll-up with the paper plans for transportation or file archives. This is a particular product benefit for historic, non-digital documents. The Decals offer a purposeful alternative to repetitive hand drafted revisions typically performed using transparent papers with non-digitized plans and documents. For the purpose of design layouts, revisions and/or corrections, the Decals can be applied and removed without loss, thereby preserving the original document or applied-upon material.

Professionals can provide the Decals to home owners to, for themselves and in their own time, demonstrate their furniture and/or fixture layout preferences with architectural elements already drawn to scale. Independently, home owners can acquire the Decals to design their own space(s) and/or organize purchases when not working with a design professional, or can have a prepared, illustrated concept for when initializing a proposed project with an industry professional.

### SUMMARY OF THE INVENTION

This invention provides Decals for printed Architectural, Engineering, Landscape and Interior Planning Drawings, for the purpose of conceptual design, project management and repetitive revisions with the preservation of the original applied-upon material. These and other advantages, features, and practical applications of the present invention will be more readily understood in view of the following detailed description and the drawings/Figures:

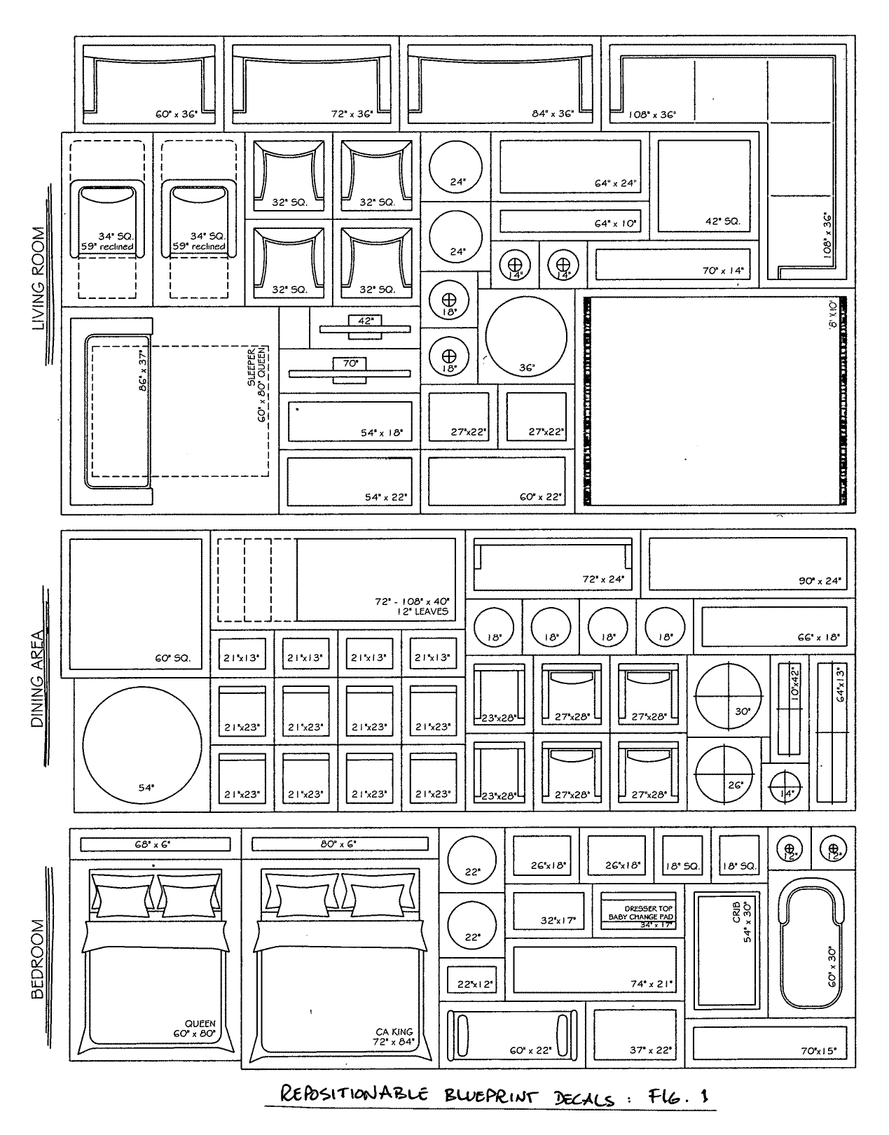

FIG. 1 is a prototype design of the Decals, demonstrating an 8.5″×11″ Master Sheet printed in a Monotone Line design at ¼″-1′0″ Architectural Scale.

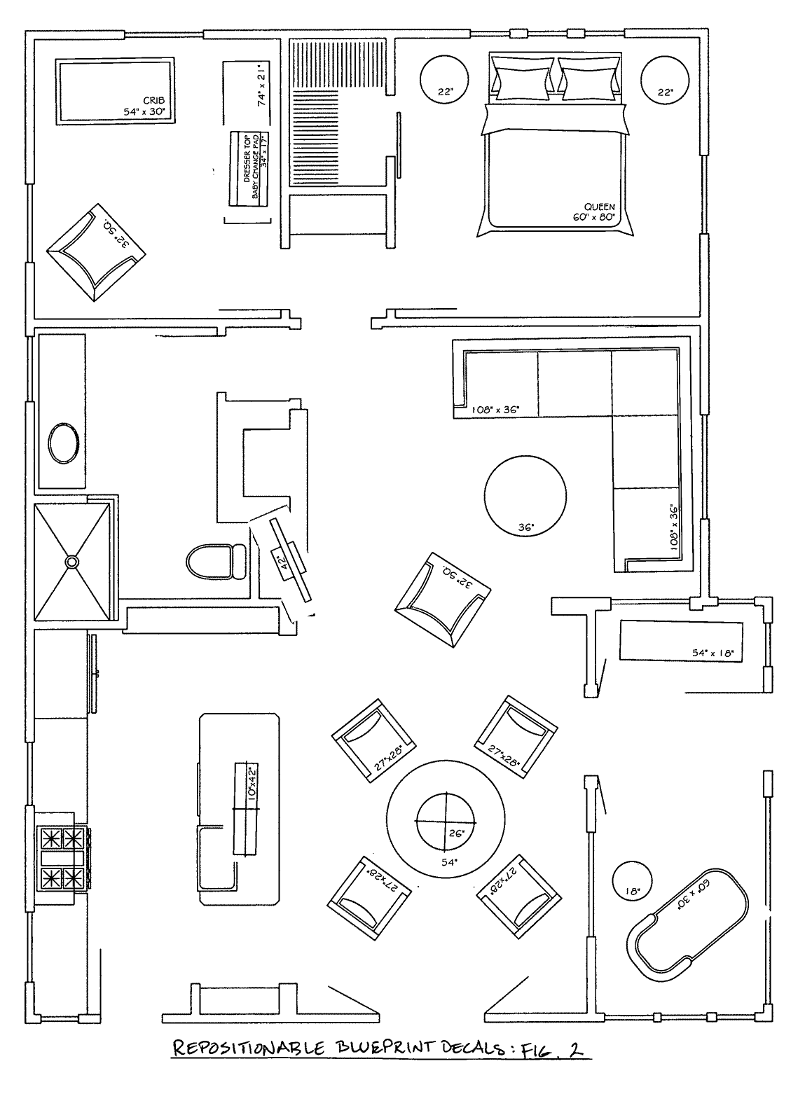

FIG. 2 is a first sample floor plan with the Decals applied, demonstrating an option for furniture arrangement.

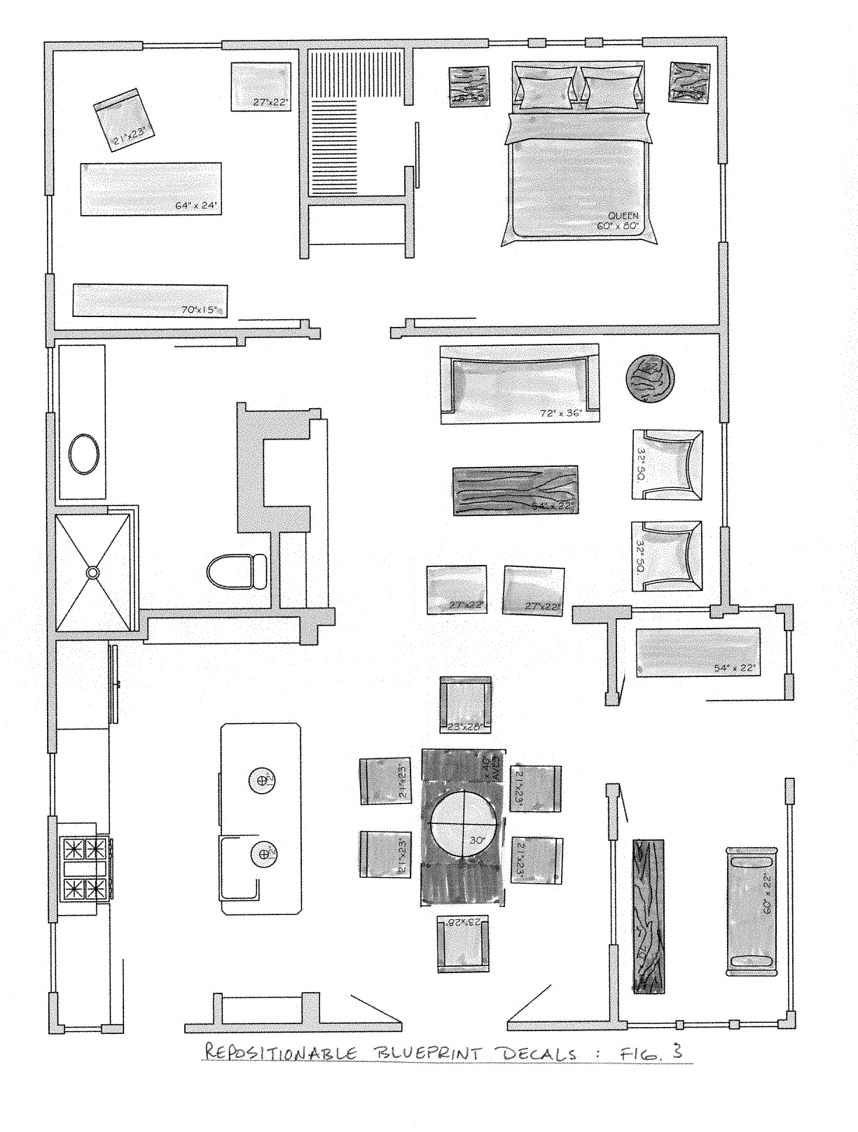

FIG. 3 is a second sample floor plan with the Decals applied, demonstrating and interchangeable layout and with the Decals colored.

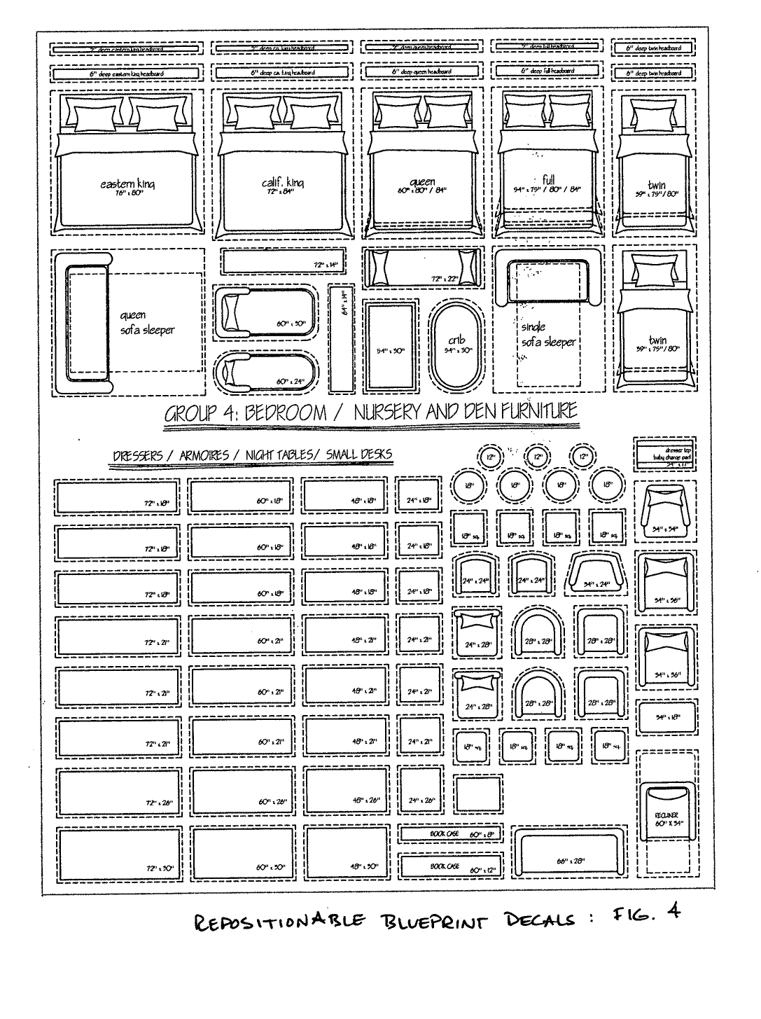

FIG. 4 is an example of how the Decals are drafted for the purpose of off-set printing and custom die cut form making. The dash-line box diagrams represent the die cut lines. Once a die is created, it cannot be changed, however, the printed graphics can be modified with-in the perimeters of the die shapes, with custom die cut designs being infinite.

I claim:

1. Decals or Repositionable Stickers comprising a plurality of shapes, graphics, diagrams or impressions of furniture, fixtures and details, as used in Architectural, Interior, Landscape and Engineering Planning and Design.

2. The Master Sheet is printed and Die Cut, resulting in pieces that peel away and can be applied to the end user's paper, plastic, glass or metal presentation board, scaled plan, document or other with the benefit of adhering or repositioning multiple times without ill-effect to the material upon which the Decal has been placed, including another Decal.

3. The Decals utilize durable yet disposable, coated or uncoated, opaque repositionable papers and/or clear polypropylene.
